(19) United States
(12) Patent Application Publication
(10) Pub. No.: US 2014/0247410 A1
(43) Pub. Date: Sep. 4, 2014

(54) PIXEL STRUCTURE AND CORRESPONDING LIQUID CRYSTAL DISPLAY DEVICE

(71) Applicant: Li Chai, Shenzhen (CN)

(72) Inventor: Li Chai, Shenzhen (CN)

(73) Assignee: Shenzhen China Star Optoelectronics Technology Co. Ltd., Shenzhen (CN)

(21) Appl. No.: 13/581,478

(22) PCT Filed: May 8, 2012
(86) PCT No.: PCT/CN12/75163

§ 371 Date: Aug. 28, 2012

(30) Foreign Application Priority Data
May 4, 2012 (CN) 201210137261.9

(51) Int. Cl. G02F 1/1362

(52) U.S. Cl. CPC G02F 1/136213
USPC 349/43; 257/57; 257/66

(57) ABSTRACT

The present invention discloses a pixel structure and a corresponding liquid crystal display device. The pixel structure has includes two data lines, two scanning lines and a pixel electrode. The pixel electrode has a cross portion that crosses over one of the scanning lines adjacent to the pixel electrode. The pixel structure and the corresponding liquid crystal display device have high aperture ratio and can be manufactured with greater stability, thereby solving the technical problem of the conventional pixel structure and the liquid crystal display device using the same on having low aperture ratio and less manufacturing stability.

### BACKGROUND OF THE INVENTION

1. Field of the Invention

The present invention relates to a field of liquid crystal display, especially to a pixel structure and a corresponding liquid crystal display device with high aperture ratio and greater manufacturing stability.

2. Description of the Related Art

Nowadays, LCD (liquid crystal display) panel sizes become larger, and users have a greater demand for wide viewing angle and low power consumption for LCD panels. Hence, it promotes the development of diversified pixel structure design of LCD.

Each pixel structure in a liquid crystal display panel has a storage capacitor mounted therein to maintain a driving voltage that activates liquid crystal molecules to twist. The capacitance of the storage capacitor should be designed according to the size of the pixel. If the capacitance of the storage capacitor is too small, the driving voltage cannot be maintained and may lead to screen flicker; if the capacitance of the storage capacitor is too large, unnecessary charging time may be increased or the storage capacitor cannot be fully charged in a certain time period and it may affect twist speed or twist angle of the liquid crystal molecules.

With reference to FIG. 1, FIG. 1 is a structural schematic view of a pixel structure according to the prior art. The pixel structure may include two data lines 11, two scanning lines 12, a thin-film transistor 13, a pixel electrode 14, an upper common electrode (not shown) disposed on a CF (color filter) substrate, and a lower common electrode 15 disposed on a TFT (thin-film transistor) array substrate. The storage capacitor is formed by the lower common electrode 15 and the pixel electrode 14. In the pixel structure, the lower common electrode is usually a metallic electrode which is not pervious to light and greatly affects the aperture ratio of the pixel structure.

With reference to FIG. 2, FIG. 2 is another structural schematic view of a pixel structure according to the prior art. The pixel structure also includes two data lines 21, two scanning lines 22, a thin-film transistor 23, a pixel electrode 24 and an upper common electrode (not shown in the figure) disposed on a CF substrate. Comparing with the former pixel structure, in this pixel structure, the lower common electrode disposed on the TFT array substrate is removed and the pixel electrode 24 extends towards one of the scanning lines 22 and partially cover the scanning line 22. The capacitor formed between the pixel electrode 24 and the scanning line 22 functions as the storage capacitor of the pixel structure. Such pixel structure can avoid the influence of storage capacitor on the aperture ratio of the pixel structure. However, in the manufacturing process of the pixel structure, because the storage capacitor is determined by the overlapping area of the pixel electrode 24 and the scanning line 22, the requirement of the forming process of the pixel electrode 24 is higher, for instance, low precision of the exposure process of forming the pixel electrode 24 may greatly affect the capacitance of the storage capacitor and further affect the display quality of the corresponding liquid crystal device.

Therefore, it is necessary to provide a pixel structure and a corresponding liquid crystal display device to overcome the problems existing in the conventional technology.

### SUMMARY OF THE INVENTION

The main objective of the invention is to provide a novel pixel structure and a corresponding liquid crystal display device with high aperture ratio and greater manufacturing stability so as to overcome the technical problem of the conventional pixel structure and the liquid crystal display device using the same on having low aperture ratio and less manufacturing stability.

In order to achieve the foregoing object of the present invention, the present invention provides a pixel structure comprising two data lines, two scanning lines being crossed with the data lines to form a pixel region; and a pixel electrode mounted in the pixel region and having a first side edge and a cross portion extended from the first side edge; the first side edge is adjacent to one of the scanning lines and the cross portion insulatedly crosses over the scanning line adjacent to the first side edge; a width of the cross portion is smaller than a length of the first side edge; and the pixel electrode further has a second side edge opposite to the first side edge and a notch portion mounted on the second side edge.

In the pixel structure of the present invention, the cross portion is rectangular, triangular or ladder-shaped.

In the pixel structure of the present invention, the shape of the notch portion corresponds to the shape of the cross portion.

The present invention further relates to another pixel structure comprising: two data lines, two scanning lines being crossed with the data lines to form a pixel region; and a pixel electrode mounted in the pixel region and having a first side edge and a cross portion extended from the first side edge; the first side edge is adjacent to one of the scanning lines and the cross portion insulatedly crosses over the scanning line adjacent to the first side edge.

In the pixel structure of the present invention, a width of the cross portion is smaller than a length of the first side edge.

In the pixel structure of the present invention, the pixel electrode further has a second side edge opposite to the first side edge and a notch portion mounted on the second side edge.

In the pixel structure of the present invention, the cross portion is rectangular, triangular or ladder-shaped.

In the pixel structure of the present invention, the shape of the notch portion corresponds to the shape of the cross portion.

The present invention further relates to a liquid crystal display device comprising a plurality of pixel structures and a driving module used to drive the pixel structures; and each of the pixel structures comprises: two data lines, two scanning lines being crossed with the data lines to form a pixel region; and a pixel electrode mounted in the pixel region and having a first side edge and a cross portion extended from the first side edge; the first side edge is adjacent to one of the scanning lines and the cross portion insulatedly crosses over the scanning line.

In the liquid crystal display device of the present invention, a width of the cross portion is smaller than a length of the first side edge.

In the liquid crystal display device of the present invention, the pixel electrode further has a second side edge opposite to the first side edge and a notch portion mounted on the second side edge.

In the liquid crystal display device of the present invention, the cross portion is rectangular, triangular or ladder-shaped.

In the liquid crystal display device of the present invention, the shape of the notch portion corresponds to the shape of the cross portion.

The pixel structure and the corresponding liquid crystal display device of the present invention use the cross portion that crosses over the adjacent scanning line to form a storage capacitor so as to increase the aperture ratio of the pixel structure, and such pixel structure can be manufactured with greater stability, thereby solving the technical problem of the conventional pixel structure and the liquid crystal display device using the same on having low aperture ratio and less manufacturing stability.

In order to make the contents of the present invention to be more easily understood, the preferred embodiments of the present invention are described in detail in cooperation with accompanying drawings as follows:

### BRIEF DESCRIPTION OF THE DRAWINGS

FIG. 1 is a structural schematic view of a pixel structure according to the prior art;

FIG. 2 is another structural schematic view of a pixel structure according to the prior art;

FIG. 3 is a structural schematic view of a pixel structure according to a preferred embodiment of the present invention;

FIG. 4 is a structural schematic view of a pixel structure according to another preferred embodiment of the present invention; and

FIGS. 5A to 5F are schematic view of possible shapes of a cross portion of the pixel structure in accordance with the present invention.

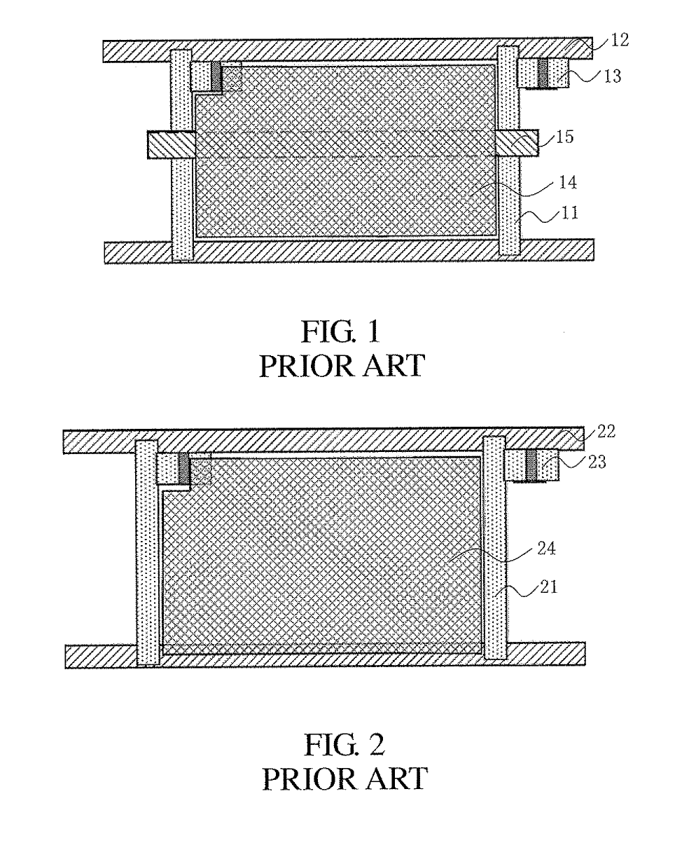

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

In the drawings, units with similar structure are labeled with the same reference number.

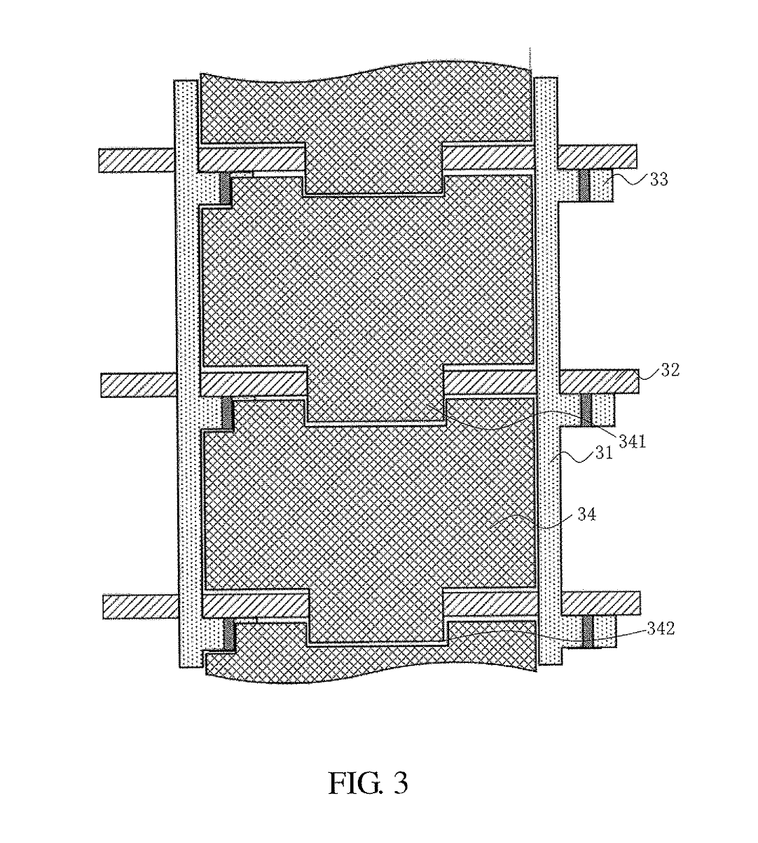

With reference to FIG. 3, FIG. 3 is a structural schematic view of a pixel structure according to a preferred embodiment of the present invention. The pixel structure includes two data lines 31, two scanning lines 32, a thin-film transistor 33 and a pixel electrode 34. The data lines 31 are used to transmit gray scale signals. The scanning lines 32 are used to transmit scanning signals and are crossed with the data lines 31 to form a pixel region. The thin-film transistor 33 includes a source, a gate and a drain, wherein the source is connected to the one of the data lines 31, the gate is connected to one of the scanning lines 32, and the drain is connected to the pixel electrode 34. The pixel electrode 34 is used to drive pixel display according to the gray scale signals and is mounted in the pixel region and has at least one cross portion 341 extended from a first side edge of the pixel electrode 34 and at least one corresponding notch portion 342 mounted on a second side edge of the pixel electrode 34. The first side edge of the pixel electrode is adjacent to one of the scanning lines (this scanning line is used to provide a scanning signal to the adjacent pixel electrode), and the second side edge is opposite to the first side edge. The cross portion 341 insulatedly crosses over the adjacent scanning line 32 adjacent to the pixel electrode 34, and the shape of the notch portion 342 corresponds to the shape of the cross portion 341 such that the adjacent pixel electrodes do not affect each other. As shown in FIG. 3, the cross portion 341 only crosses over a part of the scanning line 32 along a width direction of the scanning line 32, and does not fully cover the scanning line 32 along a length direction of the scanning line 32, that is, a width of the cross portion 341 is smaller than a length of the first side edge such that the cross portion 341 partially covers the scanning line 32.

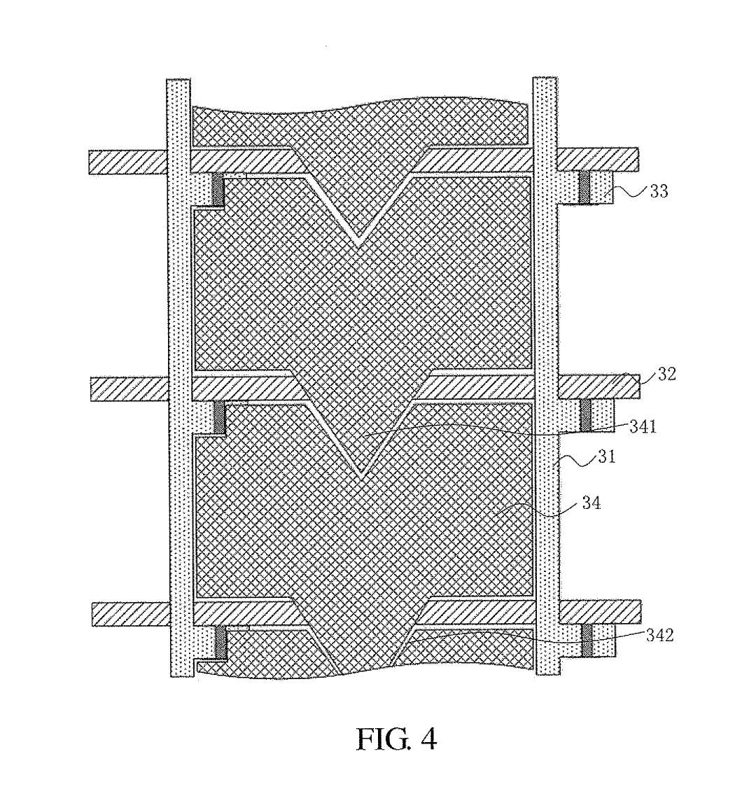

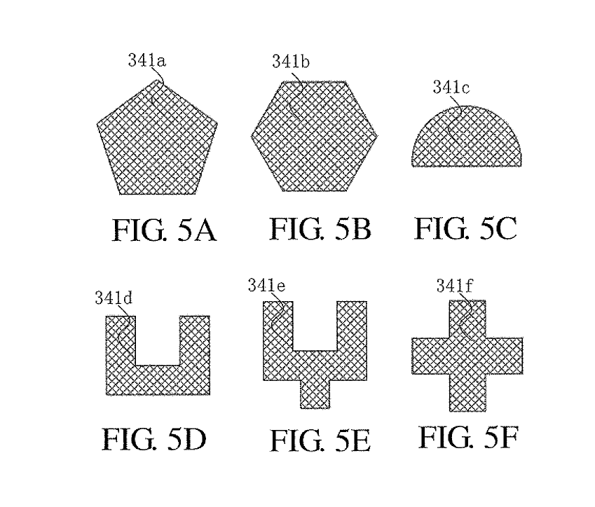

Because the cross portion 341 and the scanning 32 have an overlapping area, the overlapping area of the cross portion 341 and the scanning line 32 forms a corresponding storage capacitor, and the capacitance of the storage capacitor is related to the size of the overlapping area. Thus, a specific size and a specific shape of the cross portion 341 can be determined by the predetermined capacitance of the storage capacitor. If the storage capacitor is requested to have more capacitance, the overlapping area will be designed to have a larger size; and if the storage capacitor is requested to have relatively small capacitance, the overlapping area will be designed to have a smaller size. The cross portion 341 can be designed to have various shapes and is preferably rectangular, triangular or ladder-shaped because those shapes are relatively simple and are advantageous to manufacturing the pixel electrode 34. As shown in FIG. 4, the cross portion 341 of the pixel structure is designed to be triangular. Meanwhile, the cross portion 341 may also be designed into many shapes as shown in FIGS. 5A to 5F, wherein the shape of the cross portion 341a in FIG. 5A is a hexagon; the shape of the cross portion 341b in FIG. 5B is a pentagon; the shape of the cross portion 341c in FIG. 5C is a semicircle; the cross portion 341d in FIG. 5D is U-shaped; the cross portion 341e in FIG. 5E is Y-shaped; and the cross portion 341f in FIG. 5F is cross-shaped. It is to be noted that the shape of the cross portion 341 is not limited to the abovementioned embodiments, using a cross portion adopting other shape to implement the pixel structure of the present invention falls within the scope of the present invention. The cross portion 341 of each pixel electrode 34 of the pixel structures in the present invention preferably has the same shape such that it is advantageous to manufacturing the pixel electrode 34 and uniform image display of the liquid crystal display device.

When practicing the pixel structure of the present invention, the storage capacitor of the pixel structure is the capacitor formed between the scanning line 32 and the cross portions 341 of the pixel electrode 34, thus it does not affect the aperture ratio of the pixel structure and thereby not influencing the brightness of image display. Besides, when manufacturing the pixel structure of the present invention, since the cross portion 341 of the pixel electrode 34 crosses over a part of the scanning line 32 along the width direction of the scanning line 32, relative displacement (caused by the limited precision of an exposure equipment of photolithography) between the cross portion 341 and the scanning line 32 has little influence on the size of the overlapping area of the cross portion 341 and the scanning line 32 and even has no influence (for rectangular cross portion 341), thereby having little or no influence on the capacitance of the storage capacitor.

The present invention further relates to a liquid crystal display device which comprises a plurality of the foregoing pixel structures and a driving module. The driving module is used to drive the pixel structures. Each of the pixel structures includes two data lines, two scanning lines, a pixel electrode and a thin-film transistor. The data lines are used to transmit gray scale signals; the scanning lines are used to transmit scanning signals and crossed with the data lines 31 to form a pixel region; and the thin-film transistor includes a source, a gate and a drain, wherein the source is connected to one of the data lines, the gate is connected to one of the scanning lines and the drain is connected to the pixel electrode. The pixel electrode is used to drive pixel display according to the gray scale signals and includes at least one cross portion extended from a first side edge of the pixel electrode and a corresponding notch portion formed on a second side edge of the pixel electrode. The first side edge of the pixel electrode is adjacent to one of the scanning lines, and the second side edge is opposite to the first side edge. The cross portion insulatedly crosses over the adjacent scanning line, and the shape of the notch portion corresponds to the shape of the cross portion such that the adjacent pixel electrodes do not affect each other. The cross portion only crosses over a part of the scanning line along the width direction of the scanning line, and does not fully cover the scanning line along a length direction of the scanning line, that is, a width of the cross portion is smaller than a length of the first side edge such that the cross portion partially covers the scanning line. The size of the overlapping area of the cross portion and the scanning line is determined according to the capacitance of the desired storage capacitor. The cross portion may be designed into any kind of shape, preferably rectangular, triangular or ladder-shaped. Specific embodiments and advantages of the liquid crystal display device are the same as or similar to the aforementioned specific embodiments of the pixel structure, therefore please refer to the above description of the aforementioned embodiments for specific details of the liquid crystal display device.

The pixel structure and the corresponding liquid crystal display device of the present invention use the cross portion that crosses over the adjacent scanning line to form a storage capacitor so as to increase the aperture ratio of the pixel structure, and such pixel structure can be manufactured with greater stability, thereby solving the technical problem of the conventional pixel structure and the liquid crystal display device using the same about having low aperture ratio and less manufacturing stability.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A pixel structure comprising:
two data lines;
two scanning lines being crossed with the data lines to form a pixel region; and
a pixel electrode mounted in the pixel region and having a first side edge and a cross portion extended from the first side edge; the first side edge is adjacent to one of the scanning lines and the cross portion insulatedly crosses over the scanning line adjacent to the first side edge;
a width of the cross portion is smaller than a length of the first side edge; and
the pixel electrode further has a second side edge opposite to the first side edge and a notch portion mounted on the second side edge.

2. The pixel structure as claimed in claim 1, wherein the cross portion is rectangular, triangular or ladder-shaped.

3. The pixel structure as claimed in claim 1, wherein the shape of the notch portion corresponds to the shape of the cross portion.

4. A pixel structure comprising:
two data lines;
two scanning lines being crossed with the data lines to form a pixel region; and
a pixel electrode mounted in the pixel region and having a first side edge and a cross portion extended from the first side edge; the first side edge is adjacent to one of the scanning lines and the cross portion insulatedly crosses over the scanning line adjacent to the first side edge.

5. The pixel structure as claimed in claim 4, wherein a width of the cross portion is smaller than a length of the first side edge.

6. The pixel structure as claimed in claim 4, wherein the pixel electrode further has a second side edge opposite to the first side edge and a notch portion mounted on the second side edge.

7. The pixel structure as claimed in claim 4, wherein the cross portion is rectangular, triangular or ladder-shaped.

8. The pixel structure as claimed in claim 6, wherein the shape of the notch portion corresponds to the shape of the cross portion.

9. A liquid crystal display device comprising:
a plurality of pixel structures, and each of the pixel structures comprises:
two data lines;
two scanning lines being crossed with the data lines to form a pixel region; and
a pixel electrode mounted in the pixel region and having a first side edge and a cross portion extended from the first side edge, wherein the first side edge is adjacent to one of the scanning lines and the cross portion insulatedly crosses over the scanning line; and
a driving module used to drive the pixel structures.

10. The liquid crystal display device as claimed in claim 9, wherein a width of the cross portion is smaller than a length of the first side edge.

11. The liquid crystal display device as claimed in claim 9, wherein the pixel electrode further has a second side edge opposite to the first side edge and a notch portion mounted on the second side edge.

12. The liquid crystal display device as claimed in claim 9, wherein the cross portion is rectangular, triangular or ladder-shaped.

13. The liquid crystal display device as claimed in claim 11, wherein the shape of the notch portion corresponds to the shape of the cross portion.
